(19) United States
(12) Patent Application Publication
(10) Pub. No.: US 2004/0035375 A1
(43) Pub. Date: Feb. 26, 2004

(54) Cylinder block and crankcase for a liquid-cooled internal-combustion engine

(76) Inventors: Rudolf Gibisch, Unterschleissheim (DE); Johann Wolf, Ottobrunn (DE); Rudolf Flierl, Kaiserslautern (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/416,724

(22) PCT Filed: Feb. 8, 2002
(86) PCT No.: PCT/EP02/01313

(51) Int. Cl. F02F 1/14; F02F 7/00

(52) U.S. Cl. 123/41.74; 123/195 R

(57) ABSTRACT

A cylinder block and crankcase for a liquid-cooled internal-combustion engine is to be constructed by composite casting, a magnesium case being cast around an aluminum power unit block. The cylinder block and crankcase is conceived such that the aluminum power unit block is significantly used for the distribution of force between the cylinder head and the crankshaft bearing caps as well as for the guiding of the cooling water, in which case, the magnesium case is free of a cooling water guidance and predominantly used for the guiding of lubricating oil and, in addition, is correspondingly designed for the proportional stiffening against bending and torsion loads.

### FIELD OF THE INVENTION

The invention relates to a cylinder block and crankcase for a liquid-cooled internal-combustion engine.

### BACKGROUND AND SUMMARY OF THE INVENTION

For reducing the weight of a cylinder block and crankcase, it is known to produce the highly stressed power unit block, formed essentially of the cylinders with directly or indirectly molded-on crankshaft bearings, from a material which can withstand higher stress and to construct the less stressed case walls separately of a lighter material, with particularly thin-walled construction, while taking into account a material-adapted separate guidance for liquid fuels.

German Patent Document DE 43 06 269 A1 describes a cylinder block and crankcase for a liquid-cooled internal-combustion engine, where a power unit block with bearing blocks molded to a deck on the crankshaft side and cylinder pipes arranged above the crankshaft side is surrounded by a case shell. The case shell by way of a flange is in a sealable connection with the deck for separating the lubricating-oil-carrying crank space from a coolant space assigned to the cylinder pipes. For this cylinder block and crankcase illustrated only as an example, the use of different materials for the cylinder block and crankcase and the shell is conceivable. However, this cylinder block and crankcase is eliminated as a model for an operable internal-combustion engine.

In contrast, German Patent Document DE 44 09 750 A1 shows and describes this type of a cylinder block and crankcase for a liquid-cooled internal-combustion engine with a case consisting essentially of magnesium with a cylinder insert comprising several cylinder, pipes arranged in series. For the material-adapted separate guidance of liquid fuels, the cylinder insert, made of an aluminum alloy and surrounded by cast magnesium, in the cylinder-head-side end area, has an enveloping wall surrounding the mutually connected cylinder pipes for constructing a coolant space, so that lubricating oil as a further liquid fuel is guided preferably in ducts constructed in the magnesium case. Although, in the case of this known cylinder block and crankcase, it is ensured that cooling water as the cooling medium is not guided in the magnesium case, this magnesium case with integrated bearing blocks of a light-weight construction is not very suitable for a high-performance internal-combustion engine.

In contrast, European Patent Document EP 0 751 289 B1 shows and describes a cylinder block and crankcase for a liquid-cooled internal-combustion engine, where a power unit block, made of a ferrous material with bearing blocks arranged on a deck on the one side and cylinder pipes provided on the other side, is used in an aluminum case produced by casting around. As illustrated in the drawings of this document, the cylinder head, which is not shown, is screwed into the aluminum case, whereas the bearing caps of the crankshaft bearings are screwed to the bearing blocks formed of the ferrous material. Thus, the flux of force between the cylinder head and the crankshaft bearing caps disadvantageously extends over materials with different coefficients of thermal expansion. This requires, for example, a cylinder head gasket with a particularly high pressure.

These problems are avoided in the case of a cylinder block and crankcase for a liquid-cooled internal-combustion engine disclosed by German Patent Document DE 195 40 763 C1, where a power unit block made of a ferrous material with bearing blocks arranged on a deck on the one side and cylinder pipes in one piece are provided on the other side in addition to relatively freestanding screw channels for the cylinder head screwing. This relatively heavyweight power unit block may be surrounded by a case of cast aluminum or magnesium alloy. However in the case of a magnesium case, a costly corrosion protection must be provided in order to avoid a disadvantageous contact with the cooling water.

It is an object of the present invention to provide for a cylinder block and crankcase, produced by composite casting and made of an aluminum and a magnesium alloy, with a material-adapted separate guidance of required liquid fuels, a structure which securely absorbs forces and moments.

The advantage of the invention is that the power unit block, constructed with coolant spaces and made of an aluminum alloy, absorbs the flux of force between the cylinder head and the crankshaft bearing caps. In addition, the power unit block, during the casting around of a magnesium alloy for the case by way of fillable openings and ducts, forms a bending-resistant and torsion-proof unit together with the aluminum power unit block, which unit is advantageously supported by targeted constructed details of the magnesium case.

Advantageous further developments are also described herein.

### BRIEF DESCRIPTION OF THE DRAWINGS

The invention is described with an embodiment illustrated in the drawing.

FIG. 1 is a perspective view of a cylinder block and crankcase;

FIG. 2 is a perspective view of a power unit block according to the invention;

FIG. 3 is a sectional view of the power unit block according to Line III-III in FIG. 2;

FIG. 4 is a sectional view according to Line IV-IV in the cylinder block and crankcase according to FIG. 1; and

FIG. 5 is a detailed sectional view of a cylinder block and crankcase of a modified construction.

### DETAILED DESCRIPTION OF THE DRAWINGS

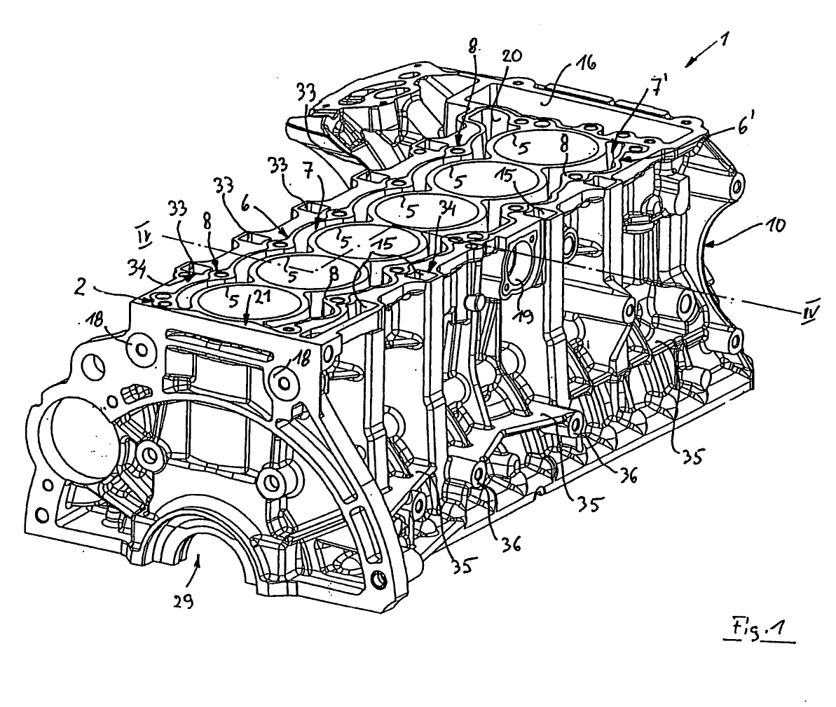

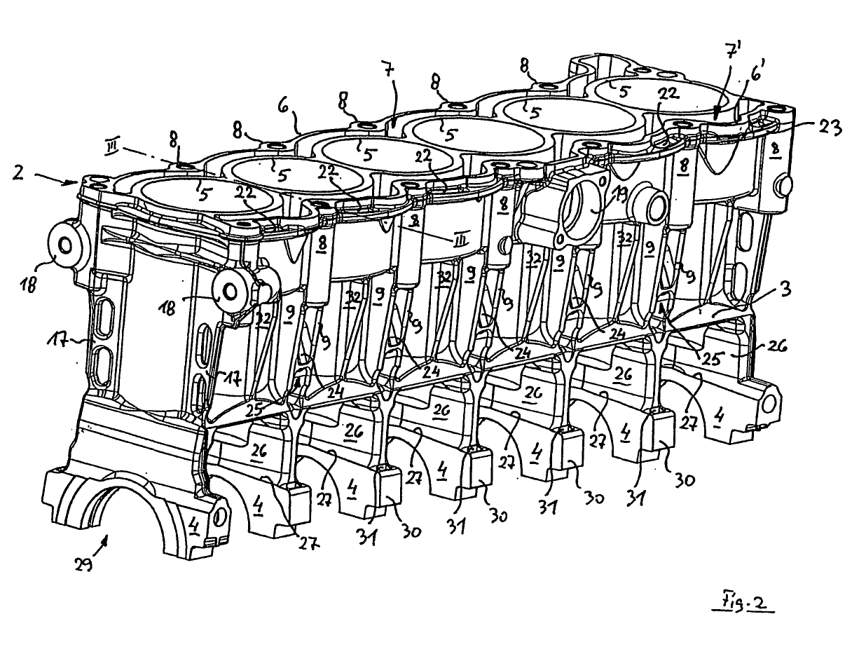

FIG. 1 illustrates a cylinder block and crankcase 1 for a liquid-cooled internal-combustion engine, which is not shown in detail. The cylinder block and crankcase 1 comprises a power unit block 2 which is made of an aluminum alloy and has bearing blocks 4 (FIG. 2) molded onto a deck 3 on the crankshaft side and cylinder pipes 5 arranged over the latter in one piece, which cylinder pipes 5 surround cylinder-head-side coolant spaces 7, 7′ with enveloping walls 6, 6′ molded to the cylinder pipes 5.

In the relatively short or low enveloping walls 6, 6′, there are screw channels 8 which are used for the fastening of the cylinder head and which are in a force-transmitting connection with the deck 3 by way of webs 9, which are arranged in the cylinder pipes 5, to the bearing blocks 4. This advantageously ensures that the flux of force between the not shown cylinder head of the internal-combustion engine and the bearing caps corresponding with the bearing blocks 4 extends exclusively in the aluminum power unit block 2 which has a higher stability.

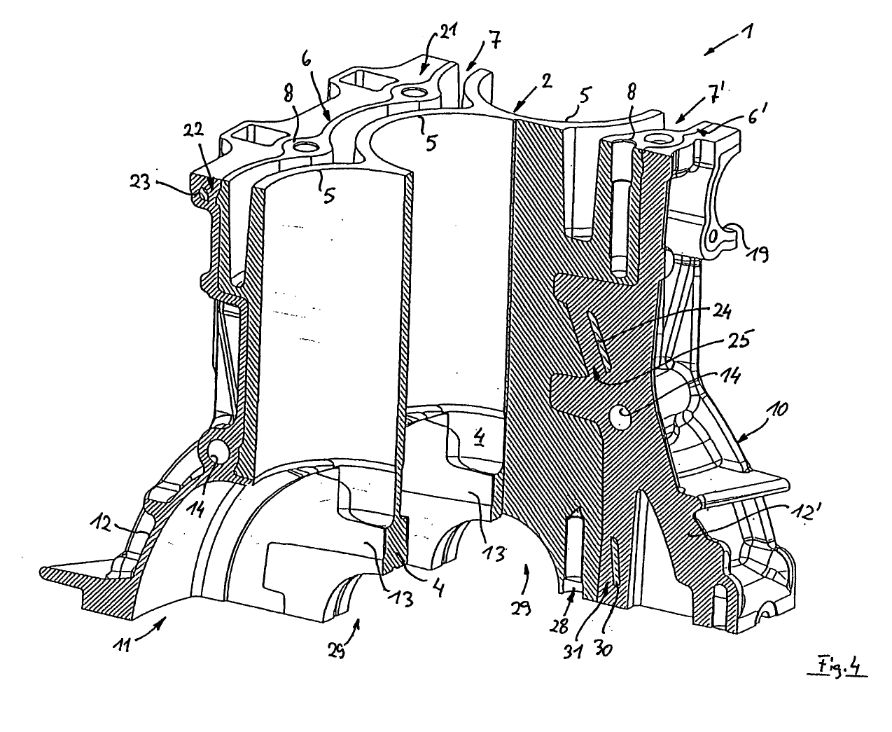

For achieving a light-weight but highly rigid cylinder block and crankcase, the aluminum power unit block 2 is cast into a case 10 made of a magnesium alloy with case wall sections 12, 12′ (FIG. 4) surrounding a crank space 11.

As illustrated in detail in FIG. 4, the mutually opposite case wall sections 12, 12′ are connected with one another by way of transverse connections 13. The bearing block 4 is cast in the transverse connections 13 to stiffen the case wall sections 12, 12′. Between the transverse connections 13 of the case wall sections 12, 12′ and the bearing blocks 4 surrounded by the casting, shrink connections are advantageously achieved which are useful for the distribution of forces and moments on the aluminum power unit block 2 and magnesium case 10.

The magnesium case 10, which is exclusively constructed for the guiding of the lubricating oil with oil channels 14, 15, is stiffened, particularly with respect to torsion, in a first end area by a face-side shaft 16 arranged in one piece (FIG. 1).

In the other, second end area, the magnesium case 10 encloses threaded eyes 18 (FIG. 2) arranged at the aluminum power unit block 2 and supported by way of ribs 17, which threaded eyes 18 are used for a releasable connection of a clutch housing or transmission housing which is not shown.

For achieving an additional clamping between the magnesium case 10 and the aluminum power unit block 2, openings and fillable channels are additionally provided in a distributed manner on the aluminum power unit block 2 which are filled by the magnesium alloy during the casting.

As illustrated in FIG. 2, the aluminum power unit block 2 comprises cylinder pipes 5 connected with the deck 3 and with one another, whereby the enveloping walls 6, 6′ surround coolant spaces 7, 7′ separated from one another by way of the connected cylinder pipes 5. As also illustrated in FIG. 2, the exhaust-gas-side coolant space 7′ is provided with an aluminum inflow piece 19 penetrating the magnesium case 10. Furthermore, the air-intake-side coolant space 7 comprises a discharge uptake 20 arranged in the first end area of the aluminum power unit block 2, which discharge uptake 20 is connected with a cylinder-head-side connection.

As illustrated in FIGS. 1 and 4, the cylinder pipes 5 and the enveloping walls 6, 6′ of the aluminum power unit block 2 together with the magnesium case 10 on the cylinder head side end flush with a common sealing surface 21. For an additional linking close to the sealing surface, the magnesium case 10 is additionally form-lockingly connected by means of openings 22 in flanges 23, which can be penetrated during the casting. The flanges 23 connect screw channels 8 on the enveloping walls 6, 6′ on the exterior side under the sealing surface 21.

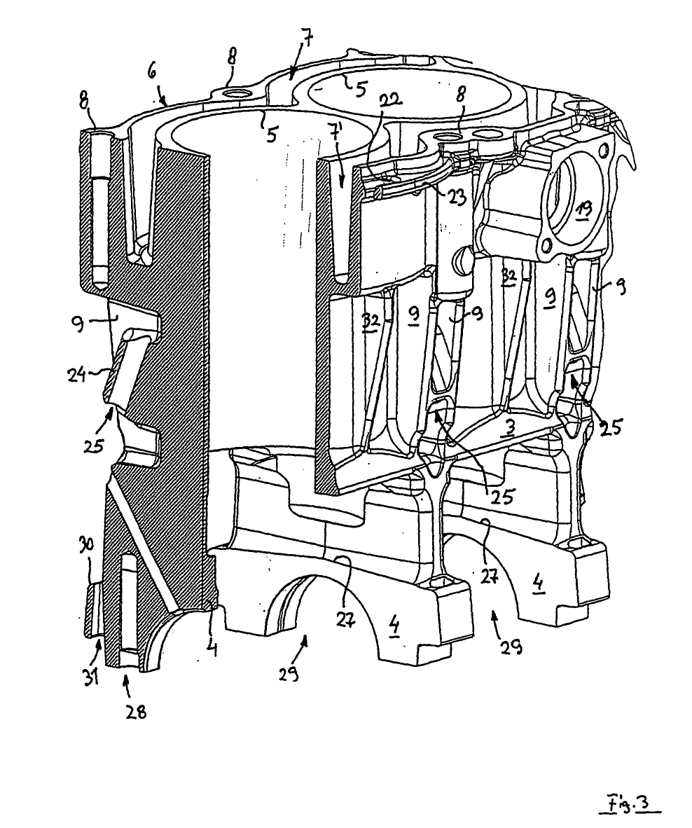

FIGS. 2 and 3 illustrate that the screw channels 8 are constructed to project over the enveloping walls 6, 6′ on the deck side and are in each case connected with the deck 3 in a force-transmitting manner by way of two webs 9 which are arranged in a mutually spaced manner below the coolant spaces 7, 7′ on the cylinder pipes 5. Together with a cylinder pipe section, and a web-connecting partition 24, the two webs 9 form a duct 25 FIG. 4 which can be filled by casting material during the casting of the magnesium case 10 around the aluminum power unit block 2, for the form-locking clamping of the magnesium case 10 with the aluminum cylinder insert 2 approximately at half the case height.

As illustrated in FIG. 2, the bearing blocks 4 at the aluminum power unit block 2, on both faces, have a groove-type indentation 26 for increasing the regional cross-section of the transverse connections 13 of the magnesium case 10. The large-cross-section belts in the transverse connections 13 are used to stiffen the case wall sections 12, 12′ of the case 10. In view of the screwed bearing cap connections in the aluminum bearing blocks 4, crankshaft-side boundaries 27 of the indentations 26 are arranged at a distance from the bearing center plane of a divided crankshaft bearing 29 which is sufficient for a load-bearing screwed bearing cap connection 28 in the bearing blocks 4.

For increasing the form-locking clamping of the transverse connections 13 of the magnesium case 10 with the aluminum bearing blocks 4, the bearing blocks 4 according to FIG. 2 have lateral extensions 30 with openings 31 which, during the casting of the magnesium case 10, can be filled by the casting material. As a result, the magnesium case 10 can also be clamped at the lower end to the aluminum power unit block 2.

As illustrated in FIG. 3, the cylinder pipes 5, between the deck 3 and the underside of the respective coolant space 7, 7′, have stiffening ribs 32 arranged approximately in the center between the webs 9 of the screw channels 8. These stiffening ribs 32 used for the stiffening of the cylinder pipes 5 advantageously enlarge the surface of the aluminum power unit block 2 for the material-locking linking of the magnesium case 10.

For the additional reinforcing or stiffening of the cylinder block and crankcase 1, the bearing caps which correspond with the bearing blocks 4 and are not shown, may be integrated in a bearing frame which is not shown, the crankshaft bearings 29, for achieving a low running play, may include cast-in parts formed of a ferrous material.

A further stiffening against bending and torsion loads is achieved in that venting ducts 33 and oil return flow ducts 15 are provided in the magnesium case 10 which are arranged to be distributed over the two longitudinal sides, which ducts 33, 15 each have a rectangular cross-section 34 oriented transversely to the longitudinal axis of the machine, the walls of the ducts 15, 33 being connected with the longitudinal case ribs 35, and, in the connection areas of the ducts and longitudinal ribs 35, screw pockets 36 designed for aluminum screws being provided for the connection of engine support elements and/or auxiliaries.

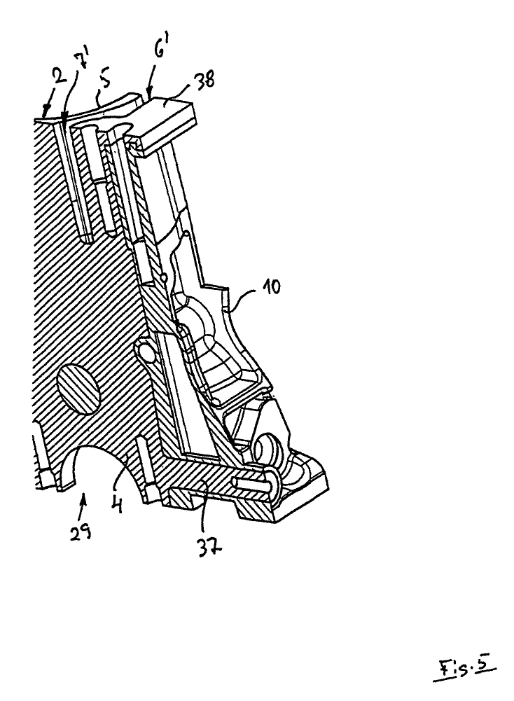

For achieving higher stressable connection points, on one or several of the bearing blocks 4 arranged on the aluminum power unit block 2, laterally oriented pin 37 may be arranged which penetrate the magnesium case 10 and each have a screw-in thread for aluminum screws for fastening separate devices (FIG. 5).

Finally, for achieving a sealing surface 21 of a uniform material, it may also be provided that the aluminum power unit block 2 has sealing flanges 38 on the enveloping walls 6, 6′ which are designed flush with the cylinder pipes 5 and cover the magnesium case 10.

The above-mentioned bearing frame accommodating the bearing blocks 4 is preferably also made of a magnesium alloy.

The cylinder block and crankcase 1 designed according to the invention is conceived such that, of the liquid fuels, the cooling water is exclusively carried in aluminum parts, whereas the lubricating oil is predominantly delivered in magnesium parts.

A eutectic or hypereutectic alusil compound is preferably considered to be used as the aluminum alloy.

1. Cylinder block and crankcase for a liquid-cooled internal-combustion engine,
comprising a power unit block (2) made of an aluminum alloy and having bearing blocks (4) molded to a deck (3) on the crankshaft side and comprising cylinder pipes (5) arranged in one piece above the latter, which
by means of enveloping walls (6, 6′) molded thereto, bound cylinder-head-side coolant spaces (7, 7′),
screw channels (8) used for the cylinder head screwing and molded out in the relatively short or low enveloping walls (6, 6′) being in force-conducting connection by way of webs (9) arranged on the cylinder pipes (5) with the deck (3), and in that further
the aluminum power unit block (2) is cast in a case (10) constructed of a magnesium alloy, with case wall sections (12, 12′) bounding a crank space (11), which case wall sections (12, 12′)
are connected with one another by way of transverse connections (13) with cast-in bearing blocks (4), further,
in that the magnesium case (10) constructed with oil ducts (14, 15) is stiffened in a first end area by means of a face-side shaft (16) arranged in one piece, and
in the other, second end area, encloses threaded eyes (18) arranged at the aluminum power unit block (2) and supported by way of ribs (17) for the releasable connection of a clutch housing or transmission housing, finally,
the magnesium case (10) being additionally connected with the aluminum power unit block (2) by way of openings and fillable ducts provided in a distributed manner on these and penetrated by the magnesium alloy.

2. Cylinder block and crankcase according to claim 1,
characterized
in that the aluminum power unit block (2) comprises cylinder pipes (5) connected with the deck (3) and with one another, and
the enveloping walls (6, 6′) bound mutually separate coolant spaces (7, 7′) by way of cylinder pipes (5) correspondingly connected in section,
the exhaust-gas-side coolant space (7′) being provided with an aluminum inflow connection (19) penetrating the magnesium case (10), and
the air-intake-side coolant space (7) having a discharge uptake (20) arranged in the first end area of the aluminum power unit block (2).

3. Cylinder block and crankcase according to claims 1 and 2,
characterized in that
the cylinder pipes (5) and the enveloping walls (6, 6′) of the aluminum power unit block (2) with the magnesium case (10) on the cylinder head side end flush in a common sealing surface (21),
the magnesium case (10) being additionally form-lockingly connected by means of openings (22) in flanges (23), which can be penetrated during the casting, which flanges (23) connect screw channels (8) on the enveloping walls (6, 6′) on the exterior side under the sealing surface (21).

4. Cylinder block and crankcase according to claims 1 to 3,
characterized in that
the screw channels (8) are constructed as projecting over the enveloping walls (6, 6′) on the deck side, and
in each case, are connected with the deck (3) in a force-conducting manner by way of two webs (9) which are arranged in a mutually spaced manner below the coolant spaces (7, 7′) on the cylinder pipes (5),
both webs (9), together with a cylinder pipe section, on the one hand, and a web-connecting partition (24), on the other hand, forming a duct (25) which, during the casting of the magnesium case (10) around the aluminum power unit block (2), can be filled by casting material, for an additional form-locking clamping of the case (10) to the cylinder insert (2).

5. Cylinder block and crankcase according to one or several of claims 1 to 4,
characterized in that
the bearing blocks (4), in both faces respectively, have a groove-type indentation (26) for the regional cross-sectional increase of the transverse connections (13) of the magnesium case (10),
crankshaft-bearing-side boundaries (27) of the indentations (26) being arranged at a distance from the center bearing plane of a divided crankshaft bearing (29) which is sufficient for a load-bearing screwed bearing cap connection (28) in the bearing blocks (4).

6. Cylinder block and crankcase according to claim 5,
characterized in that
bearing blocks (4) have lateral extensions (30) with openings (31), which
during the casting of the magnesium case (10) can be filled by casting material, for the form-locking clamping-together of the transverse connections (13) of the magnesium case (10) with the aluminum bearing blocks (4).

7. Cylinder block and crankcase according to one or several claims 1 to 6,
characterized in that the cylinder pipes (5) have stiffening ribs (32) arranged between the deck (3) and the underside of the respective coolant space (7, 7′) approximately in the center between the web pairs (9) of the screw channels (8).

8. Cylinder block and crankcase according to one or several of claims 1 to 7,
characterized in that
bearing caps corresponding with the bearing blocks (4) are integrated in a bearing frame (bedplate), and the crankshaft bearings (29) optionally comprise cast-in parts made of a ferrous material.

9. Cylinder block and crankcase according to one or several of claims 1 to 8,
characterized in that
venting and oil return flow ducts (33, 15) are provided in the magnesium case (10) which are arranged in a distributed manner over the two longitudinal sides,
which ducts (33, 15) each have a rectangular cross-section (34) oriented transversely to the longitudinal axis of the machine,
the walls of the ducts (15, 33) being connected with longitudinal case ribs (35), and
in the connection areas of both, screw pockets (36) designed for aluminum screws being provided for the connection of engine support elements and/or auxiliaries.

10. Cylinder block and crankcase according to one or several of claims 1 to 9,
characterized in that, on one or several of the bearing blocks (4) arranged on the aluminum power unit block (2), laterally oriented pins (37) are arranged which penetrate the magnesium case (10) and each have a screw-in thread, particularly for aluminum screws for fastening separate devices.

11. Cylinder block and crankcase according to one or several of claims 1 to 10,
characterized in that the aluminum power unit block (2) has sealing flanges (38) which are constructed flush with the cylinder pipes (5) on the enveloping walls (6, 6′) and cover the magnesium case (10).
